(19) United States
(12) Patent Application Publication
(10) Pub. No.: US 2016/0327365 A1
(43) Pub. Date: Nov. 10, 2016

(54) HOLOGRAPHIC WEAPON SIGHT WITH LASER MANAGEMENT SYSTEM

(71) Applicant: OptiFlow, Inc., Ann Arbor, MI (US)

(72) Inventors: Fred Collin, Brighton, MI (US); Kurt Douglas Mills, Stockbridge, MI (US); David S. Dilworth, Ann Arbor, MI (US); Rod Collin, Saline, MI (US); Stephen Michael Shubeck, Ann Arbor, MI (US); Christopher Stephen Hyde, Clarkston, MI (US)

(21) Appl. No.: 15/153,943

(22) Filed: May 13, 2016

Related U.S. Application Data
(63) Continuation-in-part of application No. 14/331,925, filed on Jul. 15, 2014.
(60) Provisional application No. 62/160,923, filed on May 13, 2015.
(60) Provisional application No. 62/005,262, filed on May 30, 2014.
(60) Provisional application No. 61/883,532, filed on Sep. 27, 2013.
(60) Provisional application No. 61/879,393, filed on Sep. 18, 2013.
(60) Provisional application No. 61/846,251, filed on Jul. 15, 2013.

(51) Int. Cl. F41G 1/30; F41G 1/54; G01K 7/04; F41G 1/34; G01K 17/00

(52) U.S. Cl. CPC F41G 1/30; F41G 1/345; G01K 17/003; G01K 7/04; F41G 1/54

(57) ABSTRACT

A compact weapon sight has a housing with a base that is configured to mount to a weapon. The sight may have a holographic optical element (HOE) and a light source. The light source may be a vertical-cavity surface emitting laser (VCSEL) diode. The wavelength of the VCSEL may be adjusted by controlling the current drawn by the VCSEL and may include a temperature controller to keep the temperature of the light source at or above a minimum threshold temperature without using a thermoelectric cooler or a wavelength sensor.

### CROSS-REFERENCE TO RELATED APPLICATIONS

This application claims the benefit of U.S. Provisional Application 62/160,923 filed on May 13, 2015. This application is a Continuation-in-part of application Ser. No. 14/331,925 filed on Jul. 15, 2014. Application Ser. No. 14/331,925 claims the benefit of U.S. Provisional Application 62/005,262 filed on May 30, 2014. Application Ser. No. 14/331,925 claims the benefit of U.S. Provisional Application 61/883,532 filed on Sep. 27, 2013. Application Ser. No. 14/331,925 claims the benefit of U.S. Provisional Application 61/879,393 filed on Sep. 18, 2013. Application Ser. No. 14/331,925 claims the benefit of U.S. Provisional Application 61/846,251 filed on Jul. 15, 2013.

### FIELD OF THE INVENTION

The present disclosure relates to a holographic weapon sight having a laser management system.

### BACKGROUND OF THE INVENTION

Holographic gun sights are well known, but typical designs are complex and may be bulky or have high energy usage. Laser diodes are used in a wide variety of applications that require a narrow spectral width. However, the wavelength of the light produced by the laser diode varies depending on a number of factors, including the temperature of the laser diode. For example, some laser diodes will exhibit a shift in output wavelength of approximately 0.30 nm/° C. The change in temperature of the laser diode may be due to environmental conditions or due to heating from operation of the diode. For some applications, this shift in wavelength is not a problem. However, for other applications, such as a holographic gun sight, this shift in wavelength may cause the holographic gun sight to be inaccurate.

In a holographic gun sight, the hologram reconstructs an image of a reticle which will appear in focus at a distance in the viewing field (Virtual Image Plane). The sight is typically designed so that this image will overlap a target. Holographic diffractive optics are wavelength dependent, thus very sensitive to changes in laser diode wavelength. As the wavelength of the light shifts, the diffraction angle from a holographic element may change, which may result in movement of the projected holographic image and give an inaccurate reticle position relative to the target.

To correct for this change in wavelength, some sights are configured such that the system of holographic elements are achromatic and compensate for changes in wavelength. However, it remains desirable (simpler design, easier manufacturing, more reliable, lower cost) to provide a source of laser-light in which the output wavelength is stable as the temperature changes within an operating range. Similar considerations apply to other devices utilizing laser light such as a stable LED, RCLED . . . etc.

One approach to addressing this problem is to control the temperature of the laser diode, such as through the use of a thermoelectric device or TEC cooler. Such control may be open or closed loop. An open loop control may be used, such as a temperature sensor attached to the laser diode. As the temperature of the laser diode changes, the TEC cooler will keep the diode at one stable temperature. For a closed loop system, the wavelength output by the laser diode may be directly monitored by a device such as a grating. This information is then used to adjust the temperature of the laser diode via the thermoelectric cooler, and bring the diode back to a desired wavelength. While thermal control of the laser diode is effective in preventing a change in wavelength, thermoelectric controllers are large in comparison to the laser diode and may draw a current in excess of 0.5 amps. For either case, using a thermoelectric cooler increases the physical size of the laser source assembly and greatly increases its energy requirements. For this reason, thermoelectric controllers in gun sights are generally impractical and undesirable. By way of example, US Patent Application Publication No. 2014/0064315 discloses another means for incorporating a thermoelectric controller in a gun sight.

An alternative type of semiconductor laser diode is known as a VCSEL, or vertical-cavity surface-emitting laser. A VCSEL has improved temperature stability as compared to a standard laser diode. For example, a VCSEL may have a wavelength shift of approximately 0.05 nm/° C., which is approximately a six-fold improvement over a standard laser diode. While this is a large improvement over the standard laser diode, even this smaller amount of wavelength shift may be enough to impair the accuracy of a device using the diode.

Parallax mismatch is also an undesired result of using holography for target shooting. Parallax mismatch results when a reconstructed reticle, also referred to as a perceived image, is displayed on an object either closer or farther than the intended distance. This means that the reconstructed reticle will appear to move around as the viewing eye moves. If the reconstructed reticle is displayed on an object at the predetermined distance from the hologram apparatus, then the image should not move. It is desired that the reconstructed reticle remains still as the viewing eye moves about a display hologram when the reconstructed reticle is displayed on objects at varying distances. This effect would improve shooting accuracy and precision. Accordingly, there is a need for a holographic weapon sight that corrects for parallax mismatch.

### SUMMARY OF THE INVENTION

The present disclosure is generally related to a sight assembly for mounting to a weapon. The sight assembly may have one or more of the features discussed herein. Some examples include an optical path with a carrier for a holographic optical element (H.O.E.) wherein a diode (specifically a wavelength stable light source in the present embodiment, however, other stabilities including mechanical, brightness . . . etc. could be utilized) is used as the virtual image reconstruction source (or real image). The optical path may utilize mirrors or lenses. The H.O.E., the diode and a mirror may be in a fixed angular configuration with respect to one another, but may be adjusted either together or individually in a horizontal or vertical direction, or rotationally. The housing may include a transparent panel allowing light to transfer therethrough allowing the mirror, diode, and an H.O.E. to be in light communication with one another. Additional features are disclosed herein.

Another aspect of the present invention relates to a stable light source. Certain embodiments of the present invention is to use a VCSEL as a light source which is driven in such a way that its wavelength output will remain stable. The wavelength of the VCSEL is controlled by controlling the current drawn by the VCSEL. This may be done by adjusting an amplitude of a current drive signal. It is desirable to maintain the VCSEL at or above a threshold temperature. If the VCSEL's temperature falls below the threshold temperature, a temperature controller may bring the VCSEL's temperature back to the threshold temperature. A detailed description of this is given below.

A compact weapon sight may include a housing that has a base configured to mount to a weapon and a holographic optical element (H.O.E.). The H.O.E. may be supported by the housing. The weapon sight also has a light source. The light source may have a laser diode operable to emit a beam of light at an output wavelength when energized, wherein the laser diode has a predefined threshold temperature. The laser diode illuminates the H.O.E. when the laser diode is energized. The weapon sight further has a power source operable to energize the light source, a sensor to determine a temperature of the light source, and an open loop current controller communicating with the sensor. The current controller is active when the temperature is at or above the predefined threshold temperature. The current controller can control a current from the power source to the laser diode and can adjust the current such that the output wavelength is approximately the same as a predetermined desired wavelength. Additionally, the weapon sight of the present invention does not use a thermoelectric cooler or a wavelength sensor.

Further, the current controller may control the current in pulses such that the light source is energized for an on-period and is not energized for an off-period of a duty cycle. The light source may be a vertical-cavity surface emitting laser (VCSEL) diode. The beam of light may illuminate the H.O.E. Further, the beam of light may be a non-collimated diverging beam of light. The weapon sight of the present invention may integrate the base of the housing with a weapon. Also, the weapon sight may include an accelerometer that is connected to the housing and is adapted to improve battery life of the sight assembly.

Furthermore, the current controller, light source, temperature sensor and the heating element may be further disposed inside a TO-Can mount. The assembly may also have an insulator that thermally insulates the light source, sensor and the heating element from the TO-Can mount.

When the current control is used for adjusting the output wavelength, it is desirable to maintain the temperature of the light source at or above the predefined threshold temperature. If the temperature of the light source falls below the threshold temperature, the light source draws relatively more current, thus shortening the battery's lifetime. In order to overcome this drawback, certain embodiments of this invention may use a temperature controller. Thus, the sight assembly may use a temperature controller when the temperature of the light source is below the threshold temperature and once the temperature is at or above the threshold temperature, the sight assembly may use the current control.

The temperature controller may further be communicating with the sensor and a heating element, the temperature controller operable to raise the temperature of the light source when the temperature falls below the threshold temperature. The temperature controller adjusts the temperature of the light source such that the output wavelength is approximately the same as a desired wavelength. The light source, sensor and the heating element may be thermally insulated from the housing.

The weapon sight may consist of a heating element operable to heat the laser diode and a temperature controller communicating with the sensor, wherein the heating element can raise the temperature of the laser diode if the temperature is below the threshold temperature. The weapon sight in accordance with the present invention may further consist of an insulator, which thermally insulates the laser diode, sensor and the heating element from the housing.

The weapon sight may also include a TO-Can mount. The temperature controller, laser diode, sensor and the heating element may be disposed inside the TO-Can mount. This embodiment may also have an insulator, wherein the insulator thermally insulates the laser diode, sensor and the heating element from the TO-Can mount.

The weapon sight according to certain embodiments of the present invention may have a sensor that is operable to determine the temperature of the laser diode. This sensor may be a voltage sensor that is operable to measure a voltage of the light source during an off-period of a duty cycle. Alternatively, the sensor may be a thermistor or a thermocouple.

Further, the present disclosure is also generally related to an assembly for correcting a parallax mismatch when viewing a reconstructed reticle through a weapon sight. The assembly may allow for virtual image distance adjustment. Accordingly, the virtual image plane can be adjusted in certain embodiments.

A method of correcting for parallax and adjusting a perceived distance of a reconstructed image is provided including the steps of providing an assembly as described above and adjusting the adjustable feature to correspond to the distance of a target object.

A beam of light from the light source may be a readout light beam having a readout light beam phasefront. The H.O.E. may be a display hologram that reconstructs a reticle when illuminated by the readout light beam, the reconstructed reticle having a perceived distance and the sight further comprising an adjustable feature operable for adjusting the readout beam phasefront before illumination of the display hologram, wherein adjustment of the adjustable feature varies the perceived distance of the reticle image.

A movable lens may be positioned to modify the phasefront of the readout light beam prior to illuminating the display hologram. A holographic optical element (H.O.E.) may be disposed in a position to be illuminated by the light source, the H.O.E. reconstructing an angled readout light beam when illuminated by the light source, the angled readout light beam illuminating the display hologram.

Another feature of certain embodiments of the present invention is that the display hologram may be fabricated from a photopolymer. The light source may be a laser light source operable for generating a laser light beam. The laser light source may be a vertical-cavity surface emitting laser (VCSEL) diode. The adjustable feature may include a rotating adjustment that modifies the perceived distance incrementally from 25 meters to 500 meters. The adjustable feature may include a rotating adjustment that modifies the perceived distance continuously from 25 meters to 500 meters. The H.O.E. may extend at least partially outside of a housing. The housing may include a transparent portion and/or a filter providing for communication between the H.O.E. and the light source. The beam of light may illuminate the H.O.E., the beam of light being a non-collimated diverging beam of light.

The H.O.E. may extend at least partially outside of the housing. The housing may include a transparent panel providing for communication between the H.O.E. and the light source. A mirror may be provided in communication with the H.O.E. and the light source. The mirror may be sealed within the chamber. A H.O.E. carrier may be provided to hold the H.O.E.

A sight assembly for mounting to a weapon may be provided, including a housing having a chamber therein and a carrier sealed within the housing. A mirror and/or a light source are mounted to the carrier. A H.O.E. is mounted to the housing, with the light source being in communication with the H.O.E. to produce a reconstructed reticle. The light source and the H.O.E. may be in a fixed angular arrangement, and an adjustment mechanism operable to adjust the vertical and/or horizontal position of the light source or the H.O.E. with respect to the housing without disrupting the fixed angular arrangement of the light source and the holographic optical element.

### BRIEF DESCRIPTION OF THE DRAWINGS

FIG. 1 is a cross-sectional view of a holographic weapon sight mounted on a weapon;

FIG. 2 is a block diagram of an embodiment of a light control system with a current and temperature controller;

FIG. 3 is a Current and Power vs. temperature chart of a light source;

FIG. 4 is a perspective view of a VCSEL diode assembly in a TO-Can;

FIG. 5 is a perspective view of the VCSEL assembly without the TO-Can;

FIG. 6 is a cross-sectional side view of the VCSEL without the TO-Can;

FIG. 7 is a view of an exemplary parts layout for a temperature controller;

FIG. 8 is a schematic showing an embodiment of a hologram image assembly according to the present disclosure in a reflection/transmission configuration;

FIG. 9 is a schematic showing an embodiment of a hologram image assembly according to the present disclosure in a reflection/reflection configuration;

FIG. 10 is a schematic showing an embodiment of a hologram image assembly according to the present disclosure in a transmission/transmission configuration;

FIG. 11 is a schematic showing an embodiment of a hologram image assembly according to the present disclosure in a transmission/reflection configuration; and

FIG. 12 is a schematic illustrating an example of wavefront/phasefront propagation.

### DETAILED DESCRIPTION OF THE INVENTION

The present invention relates generally to a sight assembly for a weapon for reconstructing a virtual image used to assist in operation of the weapon. Particular examples will be described, including a variety of features. It should be understood that other examples may include one or more of these features in any combination.

The illustrated assembly incorporates a wavelength tunable light source (specifically a VCSEL). Some embodiments of the assembly allow for slight adjustment of the fixed assembly and have a sealed configuration to achieve an improved sight assembly. The assembly may have a temperature and/or current controller for adjustment such that the output wavelength of the light source is approximately the same as a predetermined desired wavelength.

### VCSEL Current Control

A gun sight in accordance with the present invention may incorporate a control referred to herein as a smart light control. Thermal stability of the virtual image, or the observed position of the reconstructed reticle, is achieved by using a wavelength tunable source which may be a VCSEL. The need for stability is a consequence of the changes in ambient temperature. Thus, instead of using a thermoelectric device or TEC cooler to stabilize the temperature of the VCSEL, the VCSEL is used as a light source and is driven in such a way that its wavelength output is approximately the same as a predetermined desired wavelength. The wavelength of the VCSEL is controlled by controlling the current drawn by the VCSEL.

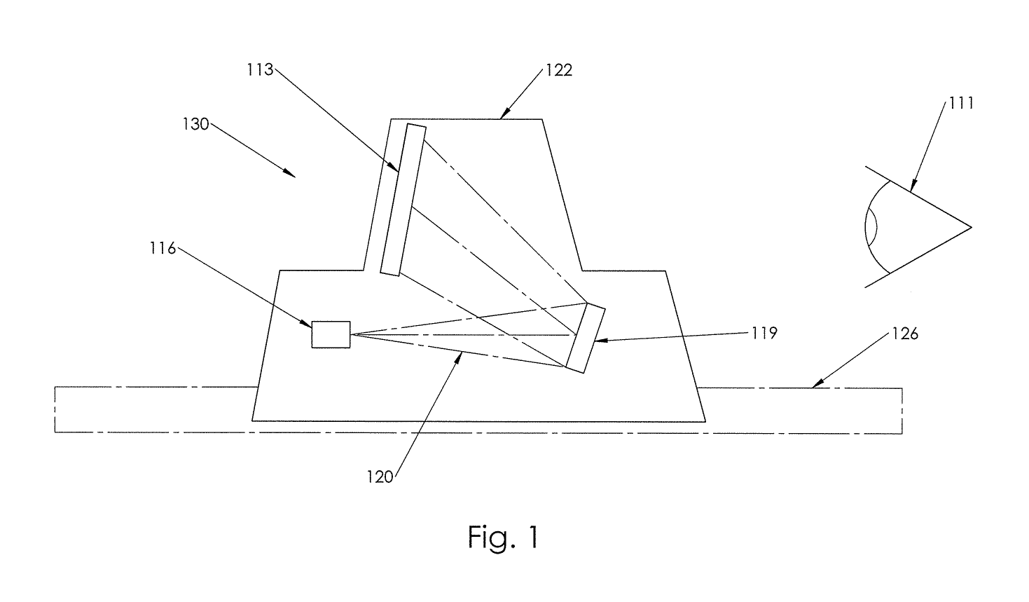

Referring now to FIG. 1, the present invention may incorporate a weapon sight 130 having a housing 122 mounted to a weapon 126. The housing 122 may have a light source 116, an optional mirror or grating 119 and a HOE 113. The light source 116 may be a VCSEL operable to emit a beam of light 120 at an output wavelength when energized. The VCSEL 116 may either illuminate the HOE 113 directly or through an optional mirror or grating 119. An user 111 may view a reconstructed reticle on the HOE 113. A reconstructed reticle is defined as a virtual image created by the HOE 113.

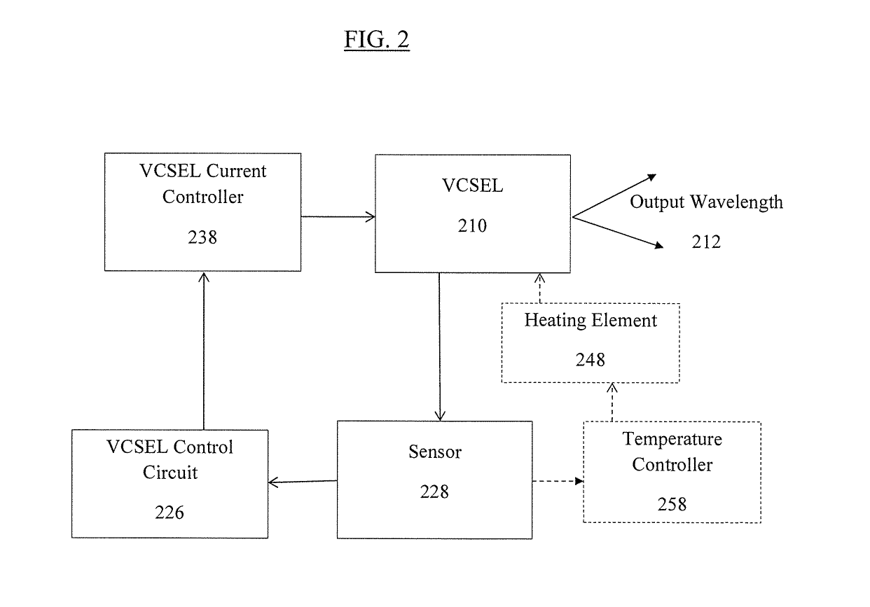

In some versions, an open loop control system may be used to control the VCSEL. In such embodiments, the output wavelength of the VCSEL is not monitored and later adjusted; instead, the temperature of the VCSEL is monitored and then the current to the VCSEL is adjusted to a value based on the known or tested characteristics of the VCSEL. FIG. 2 is a block diagram of such an exemplary embodiment of a light control system. In FIG. 2, the temperature of a VCSEL 210 is measured by a sensor 228, which transmits this information to a VCSEL control circuit 226. The VCSEL control circuit 226 is connected with the VCSEL current controller 238 that is operable to control a current provided to the VCSEL 210. The control circuit 226 and current controller 238 may be integrated into a single controller. Based on the temperature of the VCSEL 210, the current provided to the VCSEL 210 is adjusted such that an output wavelength 212 of the VCSEL 210 is approximately the same as a predetermined desired wavelength. In some examples, the temperature of the VCSEL 210 may be determined by measuring the temperature using a thermocouple, thermistor or other temperature sensing element in close proximity to the VCSEL 210. Alternatively, the temperature sensor may be in another area, such as at a distance from the VCSEL 210. Any approach to temperature sensing may be used. In another approach, the VCSEL 210 may be “interrogated” with a low level bias current during the off-period of the duty cycle. As known to those of skill in the art, the voltage of the VCSEL 210 will change with a change in the temperature. This allows the temperature of the VCSEL 210 to be directly determined. This information may then be used by the control circuit 226 to adjust the current input during the subsequent on-periods of the cycle.

The smart light control may vary the amplitude of the laser current to correct for wavelength drift caused by temperature changes. In some examples, a pulse width signal is used to energize the VCSEL. As such, the VCSEL is energized to turn the VCSEL on for an on-period and off for an off-period. This on/off cycling is very rapid such that the laser light produced by the VCSEL may appear as substantially constant to a human observer. In some examples, brightness may be adjusted by varying the duty cycle. The duty cycle can be changed by (1) modulating the pulse width and/or (2) varying the pulse repetition frequency (PRF).

In accordance with a further aspect of the present invention, a weapon sight may be constructed including a VCSEL and a current control system as described above. Alternatively, any other wavelength stable light source may be used. Such a weapon sight may reduce or eliminate the need for an achromatic system and may achieve higher levels of wavelength stability over an operating temperature range. In one example, the wavelength output of a VCSEL may change by approximately 2 nanometers over a 40° Celsius temperature range. The same VCSEL may have a current sensitivity such that a change in current will cause a 2 nanometer change in the wavelength, thereby allowing complete compensation for wavelength shift. Such a holographic sight may include an open loop control system as described above. In a further example, the control system may be used to adjust the position of a holographic image in the sight. For example, changes in wavelength may cause a change in the perceived vertical position of the holographic image in the sight. As such, the wavelength may be adjusted so as to compensate for elevation. For example, the current level may be changed so as to raise or lower the perceived position of the holographic image, depending on the design of the sight. As such, the present invention allows electronic adjustment of elevation in certain embodiments.

A VCSEL with a current control system as described above may also be used with a variety of other laser devices with a weapon sight or other devices. For example, certain types of imaging systems utilize a laser light source and it may be useful to adjust or control the output wavelength of the laser light source. Such applications form other embodiments of the present invention.

Extended battery life may be achieved by using an accelerometer to bring the unit in and out of a low power mode. When a user is not moving the weapon sight (i.e. time delay), the unit automatically goes into a low power or power saving mode. The laser light source will power down to a nonvisible optical power, such as a standby mode. When the user moves the weapon sight/device the original optical power is then returned. An accelerometer may also be used to provide other feedback to the user including, but not limited to, targeting stability and recoil intensity.

A photodiode may be used to sense ambient light levels for use with an embedded controller to adjust brightness to the user's eye automatically. The embedded controller may remember brightness levels. The embedded controller is operable to remember the previous setting. The system may also include a photodiode and/or an on-off option for energy savings. These on-off switches may be provided on the housing.

The assembly may further include a transparent portion or a filter mounted to a top portion of the housing. The transparent panel allows the diode and mirror to remain sealed within the housing but provides for the hologram outside of the housing to conserve space. The transparent panel attached to the housing allows the diode and the mirror to be in communication with the hologram allowing light to pass through the transparent portion of the housing. This holographic sight includes the illumination source and the H.O.E. The H.O.E. reconstructs the virtual image of the reticle at a known distance to produce a reconstructed reticle.

### VCSEL Temperature Control

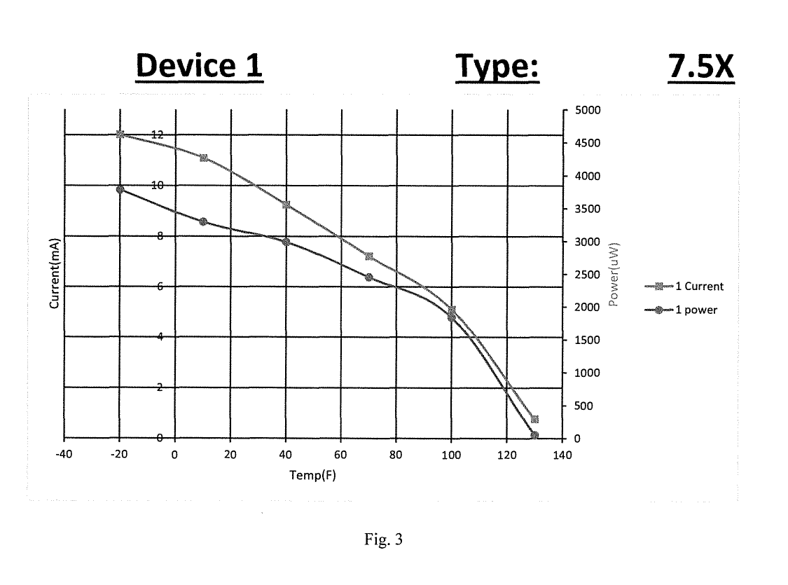

Generally, in a VCSEL there is an inverse relationship between its power consumption and the ambient temperature in which a VCSEL is operating. FIG. 3 shows a Current and Power vs. Temperature chart of a light source/VCSEL. It illustrates that the power consumption and the current drawn by a VCSEL increases as the temperature drops. The current drawn by the VCSEL at −20° F. is approximately 12 mA, whereas the current drawn by the same VCSEL at 120° F. is approximately 2 mA. Thus, the current source i.e. VCSEL draws approximately six fold more current at −20° F. than at +120° F. Generally a battery is used to power the light source. Thus the battery will last longer if used at a higher temperature in comparison to the same battery being used at a lower temperature. A predefined threshold temperature may be chosen such that if the temperature of the VCSEL falls below the threshold temperature the VCSEL draws relatively more current, thus shortening the battery's lifetime. Consequently, maintaining the temperature of a VCSEL at or above the predefined threshold temperature by using a temperature control results in longer battery life. If the temperature of the VCSEL falls below a threshold temperature, a temperature control may get activated and raise the temperature of VCSEL to or above the threshold temperature. Once the temperature of the VCSEL reaches or exceeds the threshold temperature, the current control, as described earlier, may be activated to correct the wavelength drift caused by the temperature changes. Although different threshold temperatures may be chosen depending on different circumstances, a threshold temperature of 40° F. is used for certain embodiments of the present invention. In some other embodiments, a threshold temperature of 30° F. may be used such that if the temperature of the VCSEL falls below 30° F., a temperature control may get activated and raise the temperature of the VCSEL to or above 30° F.

As shown in FIG. 2, a weapon sight may have a temperature controller 258. The sensor 228 determines the temperature of the VCSEL 210 and may provide that information to the temperature controller 258, which is connected with a heating element 248. Alternately, a separate sensor (not shown) may be used. If the temperature of the VCSEL 210 is below the threshold temperature, the temperature controller 258 may activate the heating element 248. The heating element 248 is operable to raise the temperature of the VCSEL 210. Once the temperature reaches the threshold temperature, the heating element 248 is deactivated. The temperature controller may be used in addition to the current controller. Once the VCSEL 210 reaches the threshold temperature, any change in the output wavelength 212 due to the temperature change may be adjusted by using the current controller. In certain embodiments, the current controller is not used below the threshold temperature but, alternately, it may be used.

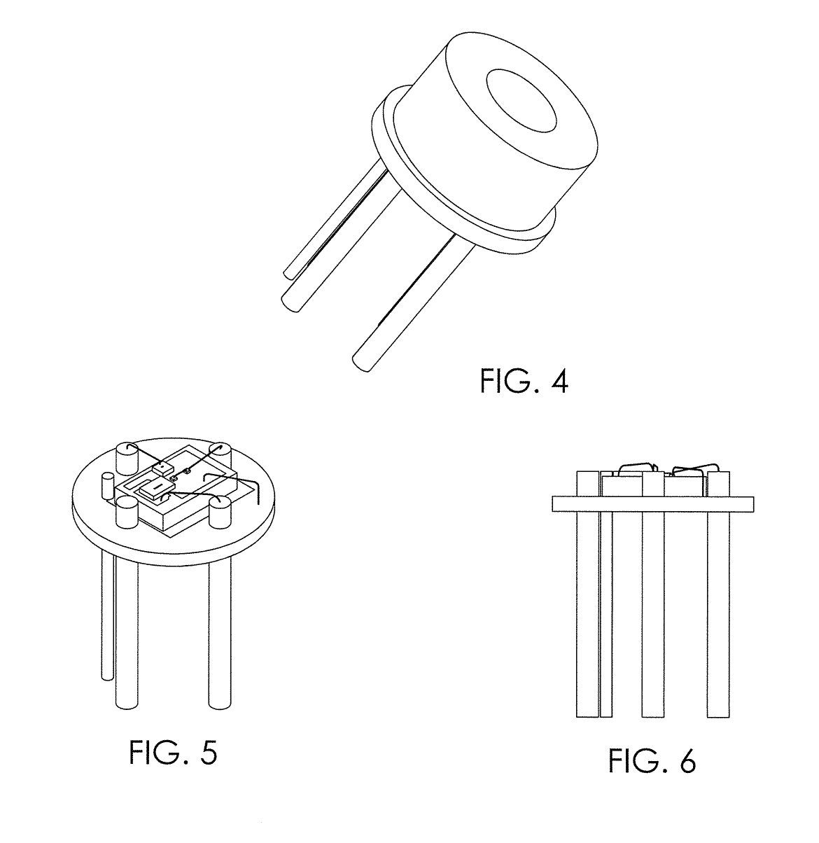

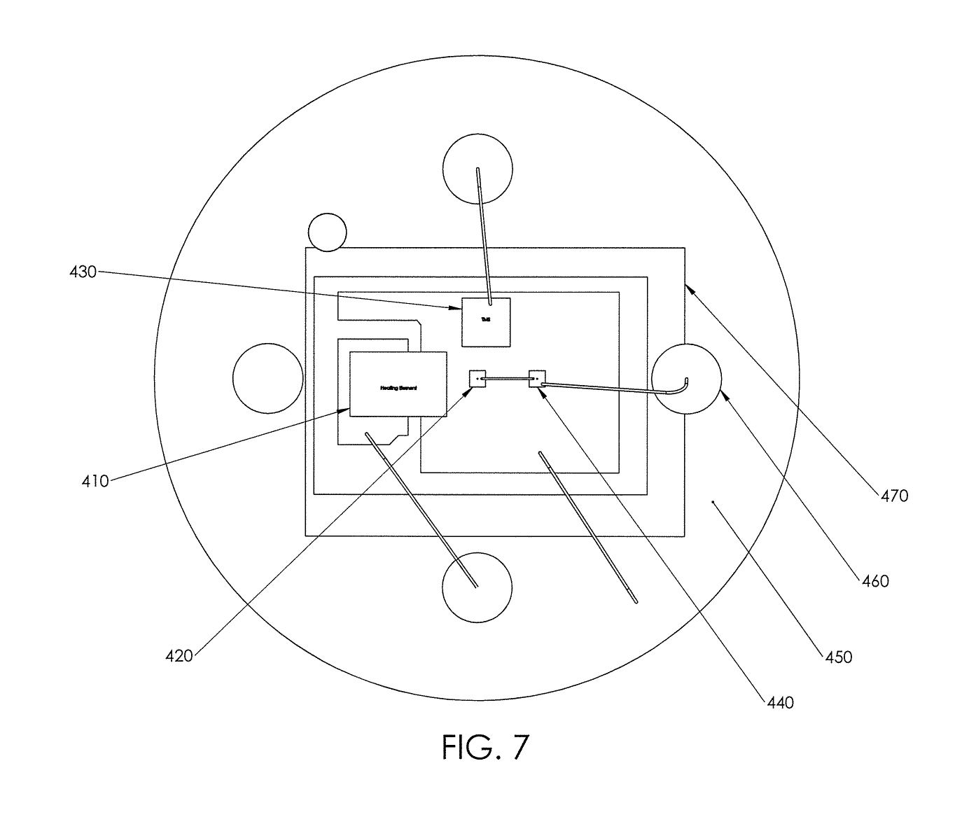

As illustrated in FIG. 4, certain embodiments of the present invention may have a temperature control disposed inside a TO-Can. FIG. 5 is a perspective view of the VCSEL assembly without the TO-Can and FIG. 6 is a cross-sectional side view of the VCSEL without the TO-Can. FIG. 7 is a view of an exemplary parts layout of a temperature controller inside a TO-Can. A sensor 430 may be positioned near the light source or VCSEL 420 to determine VCSEL's temperature. The sensor 430 may be a thermistor. In another embodiment, the sensor 420 may determine the temperature of the light source 420 indirectly. A heating element 410 may be disposed near the light source 420. The sensor 430 determines the temperature of the light source 420 and gives its feedback to the temperature controller. A light source or Vertical Cavity Surface Emitting Light (VCSEL) 420 may be connected to an electrostatic discharge (ESD) diode 440 to reduce its susceptibility to damage by ESD discharge. The ESD diode 440 may further be connected to the cathode 460.

The temperature controller may be in communication with the sensor 430 and heating element 410. If the temperature of the light source 420 is below the threshold temperature, the temperature controller activates the heating element 410 to raise the temperature to or above the predefined threshold temperature. The embodiment may have a thermal insulator 470 to thermally insulate the light source 420, ESD diode 440, heating element 410 and the temperature sensor 430 from the TO-Can. The thermal insulator 470 may be disposed on top of an anode 450. If the temperature of the light source 420 falls below the predefined threshold temperature then the light source draws more current, thus shortening the battery's lifetime. By using the temperature controller, the temperature is maintained at or above the predefined threshold temperature and therefore overcomes the drawback of drawing more current during the period of below-threshold temperature. Consequently, the lifetime of the weapon's battery is improved.

### Parallax Mismatch

The present disclosure also relates generally to sighting devices that generate a reticle or other image for aiming weapons or optical devices. Research has shown that a user of a weapon or optical device having a reticle is more likely and easily able to locate a target in comparison to a user using a “red dot” sight. A reconstructed reticle is defined as a virtual image created by a holographic element and, as used herein, is defined to include any image reconstructed by the holographic optical element, whether or not that image is a traditional reticle shape. The present disclosure provides a sight referred to as a holographic weapon sight. It comprises a light source to project a non-collimated light beam along a path. A holographic optical element (H.O.E) is disposed in the path of the light beam, which reconstructs an image of a reticle. As used herein, a holographic optical element (H.O.E) is defined as an optical element (such as a lens, filter, beam splitter, or diffraction grating) that is produced using holographic imaging processes or principles. Any embodiment of this invention may also have other optical elements, which may consist of a partial mirror, glass or dichroic film coating. As used herein, these other optical elements may redirect a pattern of light while preserving wavefront and fringe characteristics. As such, these other optical elements are not an H.O.E. When the H.O.E reconstructs the image of a reticle, this image may be viewed by looking through the H.O.E. or may be reflected in or by these other optical elements. These other optical elements may reflect the image such that it may be viewed by a user's eye. Additionally, a user may view a target through the same optical element such that the reticle is superimposed on the target. This facilitates a user for aiming the weapon or optical device. Therefore, a user may view the reticle and the target through these optical elements.

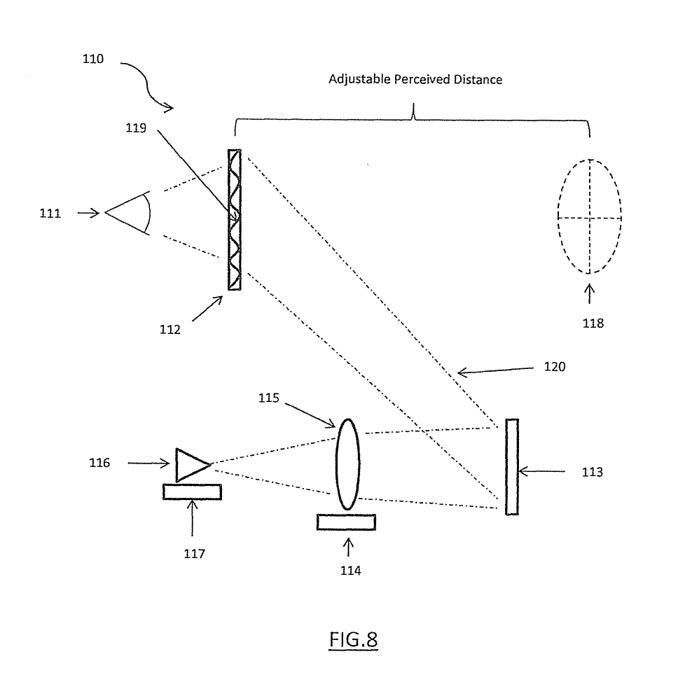

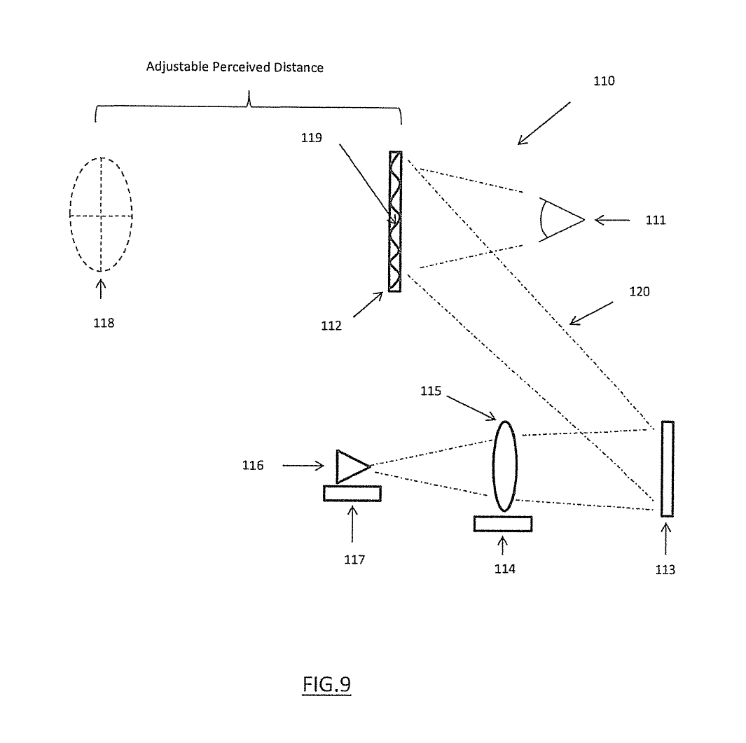

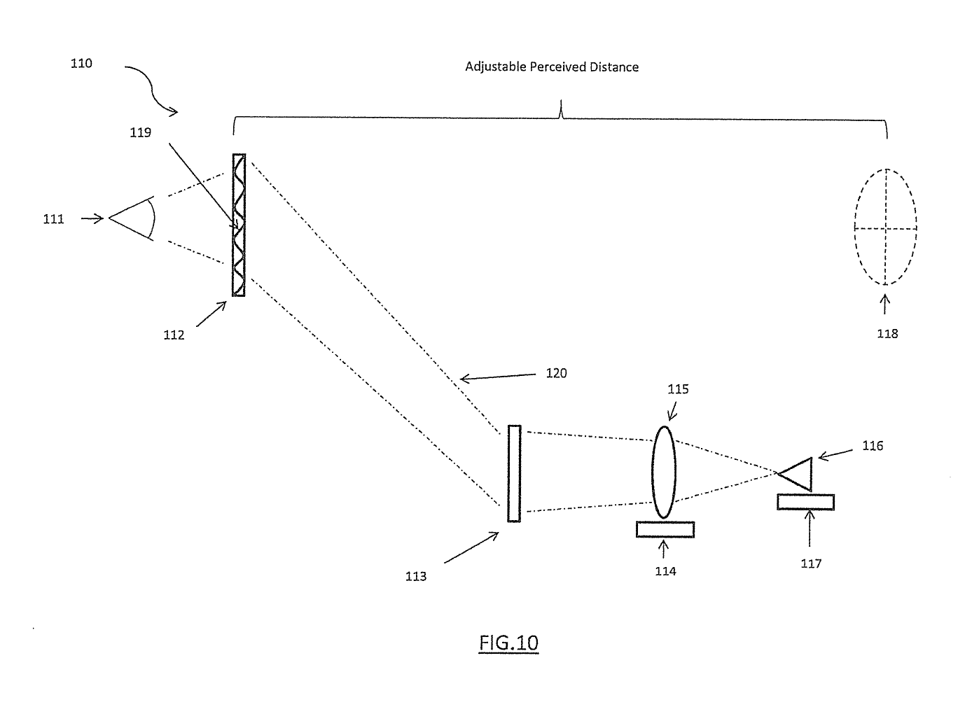

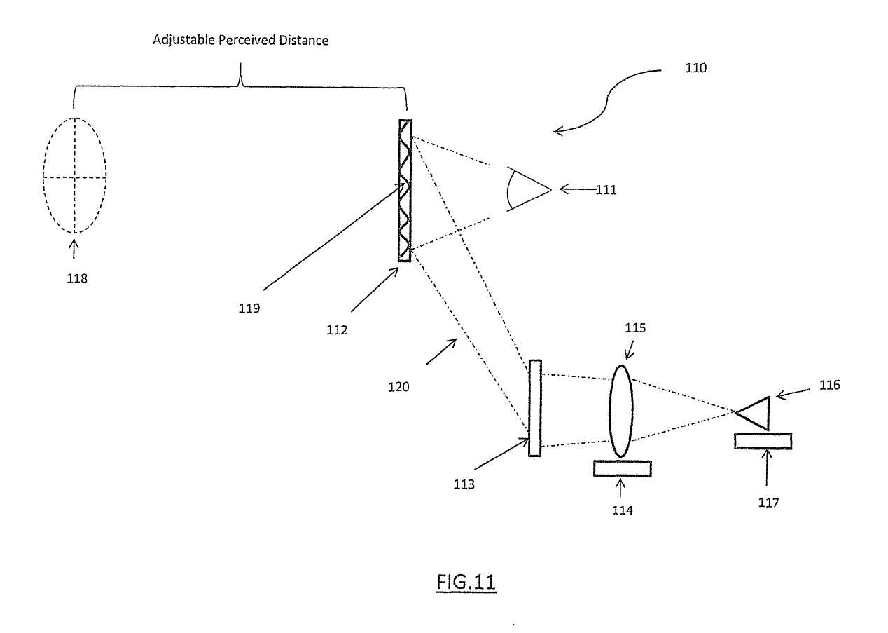

Referring now to FIGS. 8-12, certain embodiments of the present invention may incorporate an assembly 110 for holding one or more H.O.E.s that may be used with a weapon sight. The assembly 110 may allow for adjustment of a perceived distance of a reconstructed reticle 118. The assembly 110 includes a display hologram 112, also referred to as a hologram or H.O.E. The configurations as illustrated in FIGS. 8-12 may be incorporated within the housing of a weapon sight or at least partially sealed within the housing. FIGS. 8-11 schematically illustrate weapon sights configured to utilize two H.O.E. components. This configuration and technique may provide reduced wavelength effects. The first H.O.E. shapes the beam (not possible with a grating) hence creating an optical configuration not previous geometrically possible with a grating and an H.O.E.

Display hologram 112 includes a holographic wavefront of a reticle 119 (also referred to as wavefront 119) recorded thereon using any known recording technique. Wavefront 119 may be recorded onto hologram 112 by emitting a reference beam and an object beam in the presence of a reconstructed reticle or image mask thereby recording the image onto the display hologram. In one example, hologram 112 can be fabricated from a film material requiring chemical development. In this example, hologram 112 is fabricated from a photopolymer which eliminates the need for costly and hazardous chemical processing.

Wavefront 119 recorded on hologram 112 allows for a reconstructed reticle 118 to be displayed at a perceived distance from the assembly 110. The image is viewed by a user represented schematically as viewing eye 111. Displaying a perceived image 118 occurs when the hologram 112 is illuminated by a readout beam corresponding to or matching the light beam used during recording. In one example, the hologram is illuminated directly from a reference light beam source. In this example, the readout light beam is an angled light beam 120 from an H.O.E. 113. Angled light beam 120 is a readout beam in these examples. In another example, a grating can be used.

H.O.E. 113 can also be fabricated from a photopolymer. In this example, diffracted light from H.O.E. 113 (light beam 120) illuminates the H.O.E. 112. Accordingly, light source 116, when activated, emits a light beam that illuminates H.O.E. 113. In an example, light source 116 can be a laser light source operable for emitting a laser light beam. In a further example, the laser light source is a vertical-cavity surface-emitting laser (“VSCEL”). Any other narrow spectrum source may also be utilized.

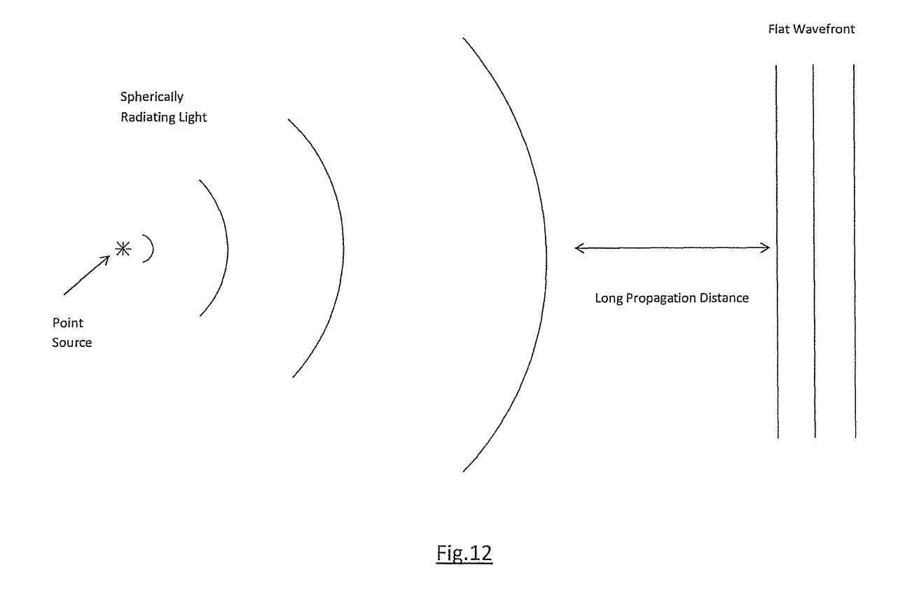

A lens 115 can be provided between the light source 116 and the H.O.E. 113. Lens 115 can be used to change the phasefront or wavefront of the light before illuminating. FIG. 12 illustrates how the wavefront of light waves propagate (and become flatter with distance) as they move away from the source. Adjustment of the phasefront corrects for parallax mismatch of the perceived image 118 by adjusting the perceived distance of the perceived image. The phasefront can be adjusted by adjusting either the lens 115 position or the light source 116 position, relative to the H.O.E. 113. In this example, the lens 115 can be adjusted along a lens adjustment track. Lens adjustment track 114 can be adjusted manually by hand either continuously or incrementally corresponding to varying perceived distance. Likewise, light source 116 can be adjusted via a light source adjustment track 117. In an example, more than one lens is used and it is conceivable that lens assemblies having a plurality of lenses are used. It is further possible that these lenses can be individually or collectively adjusted to generate various magnifications. In yet a further example, adjustment of the position of the H.O.E. and/or the display hologram can also impact the perceived distance of the reconstructed reticle.

The invention is not restricted to the illustrative examples and embodiments described above. The embodiments are not intended as limitations on the scope of the invention. Methods, apparatus, compositions, and the like described herein are exemplary and not intended as limitations on the scope of the invention. Changes therein and other uses will occur to those skilled in the art. The scope of the invention is defined by the scope of the claims.

1. A compact weapon sight, comprising:
a housing having a base configured to mount to a weapon;
a holographic optical element (H.O.E.), the H.O.E. supported by the housing;
a light source, the light source having a laser diode operable to emit a beam of light at an output wavelength when energized, the laser diode illuminating the H.O.E. when the laser diode is energized;
a power source operable to energize the light source;
a sensor for determining a temperature of the light source, the laser diode having a predefined threshold temperature; and
an open loop current controller communicating with the temperature sensor, the current controller operable when the temperature is at or above the predefined threshold temperature, the current controller operable to control a current from the power source to the laser diode, the current controller operable to adjust the current such that the output wavelength is approximately the same as a predetermined desired wavelength;

2. The weapon sight in accordance with claim 1, further comprising:
a heating element operable to heat the laser diode; and
a temperature controller communicating with the sensor, the temperature controller operable to raise the temperature of the laser diode when the temperature is below the predefined threshold temperature.

3. The weapon sight in accordance with claim 2, further comprising:
an insulator that thermally insulates the laser diode, sensor and the heating element from the housing.

4. The weapon sight in accordance with claim 2, further comprising:
a TO-Can mount;
wherein the temperature controller, laser diode, sensor and the heating element are disposed inside the TO-Can mount.

5. The weapon sight in accordance with claim 4, further comprising:
an insulator;
wherein the insulator thermally insulates the laser diode, sensor and the heating element from the TO-Can mount.

6. The weapon sight in accordance with claim 1, wherein the sensor is operable to measure a parameter related to the temperature of the laser diode.

7. The weapon sight in accordance with claim 6, wherein the sensor comprises a voltage sensor operable to measure a voltage of the light source during an off-period of a duty cycle.

8. The weapon sight in accordance with claim 6, wherein the sensor comprises a thermistor or a thermocouple.

9. The weapon sight in accordance with claim 1, wherein the current controller controls the current in pulses such that the light source is energized for an on-period and is not energized for an off-period of a duty cycle.

10. The weapon sight in accordance with claim 1, wherein the base of the housing is integral with a weapon.

11. The weapon sight in accordance with claim 1, wherein the compact weapon sight does not use a thermoelectric cooler or a wavelength sensor.

12. The weapon sight in accordance with claim 1, further comprising:
an accelerometer connected to the housing;
wherein the accelerometer is adapted to switch the weapon sight to a low power or power saving mode after a predetermined period of time of inactivity of the weapon sight and to return the weapon sight to a normal mode when the weapon sight is moved or becomes active to improve battery life of the sight assembly.

13. The weapon sight in accordance with claim 1, further comprising:
an accelerometer connected to the housing;
wherein the accelerometer is adapted to provide a user feedback of a target stability and/or recoil intensity based on the movement of the weapon sight.

14. The weapon sight in accordance with claim 1, wherein the laser diode is a vertical-cavity surface emitting laser (VCSEL) diode.

15. The weapon sight in accordance with claim 1, wherein:
the beam of light from the laser diode is a readout light beam having a readout light beam phasefront;
the H.O.E. is a display hologram that reconstructs a reticle when illuminated by the readout light beam, the reconstructed reticle having a perceived distance; and
the sight further comprising an adjustable feature operable for adjusting the readout beam phasefront before illumination of the display hologram, wherein adjustment of the adjustable feature varies the perceived distance of the reticle image.

16. The weapon sight in accordance with claim 15, wherein the adjustable feature comprises a movable lens positioned to modify the phasefront of the readout light beam prior to illuminating the display hologram.

17. The weapon sight in accordance with claim 15, further comprising a holographic optical element (H.O.E.) disposed in a position to be illuminated by the laser diode, the H.O.E. reconstructing an angled readout light beam when illuminated by the laser diode, the angled readout light beam illuminating the display hologram.

18. The weapon sight in accordance with claim 1, wherein the current controller is operable only when the temperature is at or above the predefined threshold temperature.
